(19) United States
(12) Patent Application Publication
(10) Pub. No.: US 2004/0128445 A1
(43) Pub. Date: Jul. 1, 2004

(54) Cache memory and methods thereof

(76) Inventors: Tsafrir Israeli, Yokneam Ilit (IL); Alexander Meidel, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/335,109

(22) Filed: Dec. 31, 2002

(51) Int. Cl. G06F 12/00

(52) U.S. Cl. 711/129; 711/5

(57) ABSTRACT

Briefly, a cache memory and a portable apparatus including a cache memory is provided. The cache memory may include one or more banks, wherein each of said banks is partitioned into two or more portions and each of said portions may be powered independently of other of said portions.

### BACKGROUND OF THE INVENTION

Computer designs may be directed to save energy. In particular, in portable devices the length of the battery life is of importance. One area in which a designer may deal with power saving is the operation of the cache memory. A cache may be divided into banks, in such a design one may not power banks that are not utilized in order to save power. However, such an approach is limited in the power savings that it may achieve.

Thus, there is a need for better ways for providing a cache memory which may achieve power saving.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a block diagram of an apparatus including a cache memory according to an embodiment of the present invention;

FIG. 2 is a block diagram of a cache memory according to an embodiment of the present invention; and

FIG. 3 illustrates the operation of a logic circuit of a cache memory according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

It should be understood that the present invention may be used in any apparatus having a processor and a cache memory. Although the present invention is not limited in this respect, the apparatus may be a portable device that may be powered by a battery. Non-limiting examples of such portable devices include laptop and notebook computers, mobile telephones, personal digital assistants, and the like. Alternatively, the apparatus may be a non-portable device, such as, for example, a desktop computer.

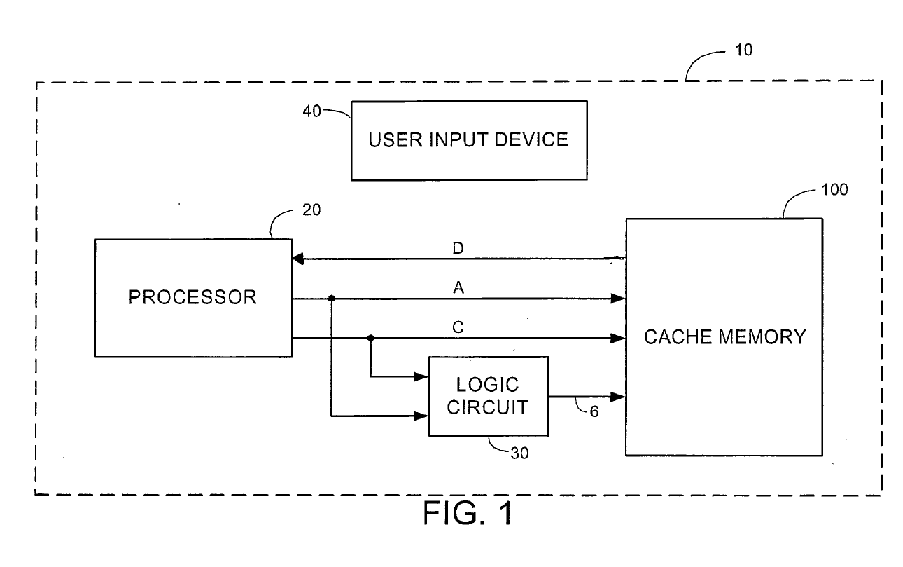

Turning first to FIG. 1, an apparatus 10 according to some embodiments of the present invention is shown. Apparatus 10 may comprise a processor 20 and a cache memory 100, which may be coupled by address signals A, data signals D and control signals C to processor 20. Control signals C and address signals A may be input into a logic circuit 30, the output of which may be signals 6 that control the powering of and access to cache memory 100, as will be described in more detail hereinbelow. Although the present invention is not limited in this respect, processor 20 may be, for example, a central processing unit (CPU), a digital signal processor (DSP), a reduced instruction set computer (RISC), a complex instruction set computer (CISC) and the like. In addition, cache memory may include or may be, for example, dynamic read access memory (DRAM), a Flash memory, Static RAM (SRAM) and the like. Although the present invention is not limited in this respect, processor 20 and cache memory 100 may be present on the same semiconductor die, or may be part of the same multi-chip module (MCM), or alternatively, processor 20 may be part of a packaged integrated circuit and cache memory 100 may be part of a different packaged integrated circuit.

Although the scope of the present invention is not limited to this embodiment, in operation, processor 20 may read or write from cache memory 100.

In another embodiment of the present invention, processor 20 may comprise logic circuit 30.

Apparatus 10 may comprise a user-input device 40. Although the scope of the present invention is not limited in this respect, user-input device 40 may be a full or partial keyboard, a touch-pad, a trackball, a touch screen, a microphone, a dial pad, and the like.

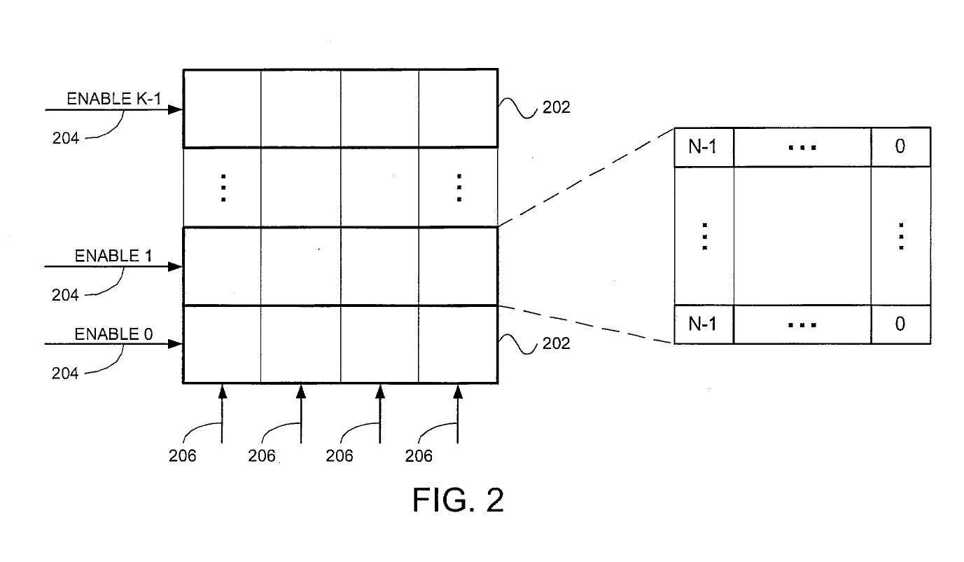

Turning now to FIG. 2, cache memory 100 according to an embodiment of the present invention is shown. Although the scope of the present invention is not limited in this respect, cache memory 100 may include K banks 202, each comprising rows of N bytes, for example, rows of 8 bytes. Although several banks 202 are illustrated in FIG. 2, it is known in the art that cache memory 100 may comprise only one bank 202 (i.e. K=1). As is known in the art, each bank 202 may be powered and accessed independently of the others (shown by ENABLE lines 204).

According to some embodiments of the present invention, each bank 202 may be partitioned into two or more portions, each of which may be powered and accessed independently of the others (shown by ENABLE lines 206). The portions may be of equal width or of different widths. It will be appreciated by persons of ordinary skill in the art that by activating a single one of ENABLE lines 204 and a single one of ENABLE lines 206, a particular portion of a particular bank 220 may be powered and accessed, while the other portions of cache memory 100 remain unpowered and inaccessible.

It will be appreciated by persons of ordinary skill in the art that the selection of a particular portion of cache memory 100 to be powered may be dependent upon the address to be accessed by processor 20, the width to be accessed by processor 20, or both. Although the present invention is not limited in this respect, these selection criteria may be retrieved from address and/or control signals of processor 20, the format of instructions of processor 20, and/or the microcode of the executed instructions of processor 20.

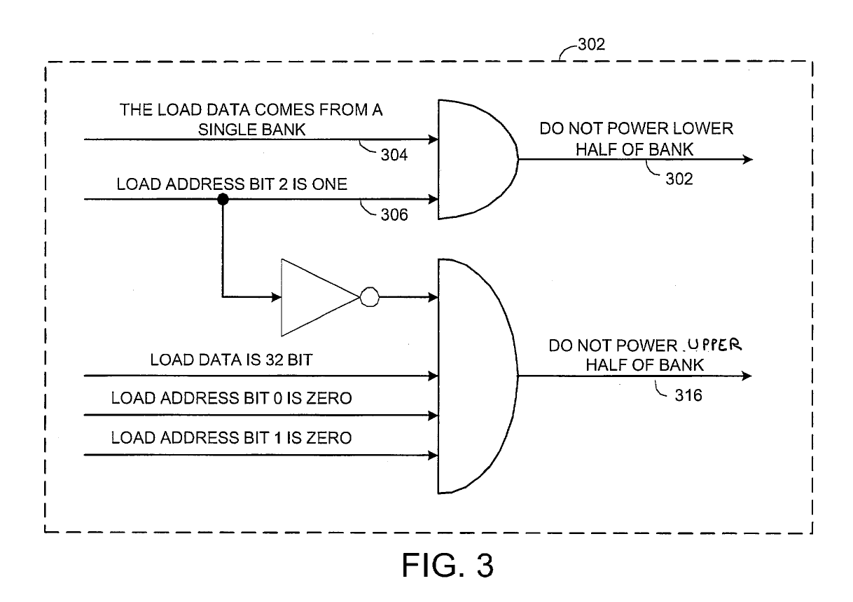

Turning now to FIG. 3, the operation of logic circuit 30 according to an embodiment of the present invention is shown. Although the scope of the present invention is not limited to this embodiment, FIG. 3 illustrates a logic circuit 30 that controls the powering of a cache memory with banks having a width of 8 bytes and two equal portions. Although the scope of the present invention is not limited to this embodiment, FIG. 3 also indicates the conditions for not powering the lower portion of the bank or the higher portion of the bank. In the example of FIG. 3 which does not limit the scope of the present invention, logic circuit 30 does not enable the lower half of the bank to be powered and accessed (as indicated by 302) if the load data comes from a single bank (as indicated by 304) and bit 2 of the load address has the value 1 (as indicated by 306).

FIG. 3 also shows an example which does not limit the scope of the present invention as to the conditions under which the higher half of the bank will be unpowered and inaccessible. In this example, the conditions comprise bits 0, 1 and 2 of the load address all having the value zero and the load data having a size of 32 bits (4 bytes). If these conditions are fulfilled, logic circuit 30 does not provide a power instruction to the upper half of the bank (as indicated by 316) and the higher half of the bank remains unpowered and inaccessible.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
providing a cache memory comprising one or more banks, wherein each of said banks is partitioned into two or more portions and each of said portions is able to be powered independently of other of said portions.

2. The method of claim 1, further comprising:
providing a logic circuit coupled to said cache memory to determine which of said two or more portions to power when said cache memory is to be accessed.

3. A method comprising:
powering one or more selected portions of a bank of a cache memory without powering other portions of said bank.

4. The method of claim 3, further comprising:
determining said selected portions based at least in part on an address to be accessed, the width to be accessed or a combination thereof.

5. A cache memory comprising one or more banks, wherein each of said banks is partitioned into two or more portions and each of said portions is able to be powered independently of other of said portions.

6. The cache memory of claim 5, wherein each of said banks is partitioned into a first half and a second half.

7. The cache memory of claim 6, wherein the width of each bank is 8 bytes.

8. A portable apparatus comprising:
a user-input device; and
a cache memory comprising one or more banks, wherein each of said banks is partitioned into two or more portions, and each of said portions is able to be powered and accessed independently of other of said portions.

9. The portable apparatus of claim 8, wherein each bank of said one or more banks is divided into a first half and a second half.

10. The portable apparatus of claim 8, further comprising:
a processor coupled to said cache memory; and
a logic circuit to receive one or more signals from said processor and to enable powering each of said portions independently of other of said portions.

11. The portable apparatus of claim 10, wherein said signals are one or more of address and control signals.

12. The portable apparatus of claim 8, further comprising:
a processor coupled to said cache memory, said processor comprising a logic circuit to enable powering each of said portions independently of other of said portions.

13. An apparatus comprising:
a cache memory comprising one or more banks, wherein each of said banks is partitioned into two or more portions, and each of said portions is able to be powered and accessed independently of other of said portions.

14. The apparatus of claim 13, wherein each bank of said one or more banks is divided into a first half and a second half.

15. The apparatus of claim 13, further comprising:
a processor coupled to said cache memory; and
a logic circuit to receive one or more signals from said processor and to enable powering each of said portions independently of other of said portions.

16. The apparatus of claim 15, wherein said signals are one or more of address and control signals.

17. The apparatus of claim 13, further comprising:
a processor coupled to said cache memory, said processor comprising a logic circuit to enable powering each of said portions independently of other of said portions.
